(19) United States
(12) Patent Application Publication
(10) Pub. No.: US 2005/0094967 A1
(43) Pub. Date: May 5, 2005

(54) Dynamic compression of a video stream

(76) Inventors: Jeffrey F. Hatalsky, Framingham, MA (US); Senthilkumar Manickavasagam, Randolph, MA (US); John R. Fierke, Hopkinton, MA (US)

Correspondence Address: EITAN, PEARL, LATZER & COHEN ZEDEK, LLP., 10 ROCKERFELLER PLAZA, SUITE 1001, NEW YORK, NY, 10020, US

(21) Appl. No.: 10/696,600

(22) Filed: Oct. 29, 2003

(51) Int. Cl. H04N 5/76; G11B 27/00

(52) U.S. Cl. 386/52; 386/55

(57) ABSTRACT

A method for displaying data representative of a video stream by providing frames containing progressively-encoded frame data. These frames represent a portion of the video stream. A selected extent of the frame data contained in each frame is fetched, and a video stream corresponding to the selected extents is displayed.

### FIELD OF INVENTION

The invention relates to image processing, and in particular, to systems for editing film and/or video.

### BACKGROUND

The image one sees on a television screen is often a composite of several independent video streams that are combined into a single moving image. For example, when watching a commercial, one might see in actor standing in what appears to be an exotic location.

Appearances notwithstanding, the actor is far more likely to be standing in front of a green background in a studio. The image of the exotic background and that of the actor are created separately and stored as separate video files representative of a separate video streams. Using a digital video editing system, a video editor combines and manipulates these separate video streams to create the image one finally sees on the television screen.

To work more effectively, an editor often finds it necessary to simultaneously view several video streams. This requires transmitting data representative of those video streams from one or more disks to a display device. This transmission typically requires placing the data on a transmission channel between the disks, on which the data is stored, and a processor, at which that data is translated into a form suitable for display.

A difficulty associated with the transmission of video data is the finite capacity of the transmission channel. Known transmission channels lack the capacity to transmit multiple high-definition video streams fast enough to provide smooth, uninterrupted motion in the displayed image.

A known way to overcome this difficulty is to maintain compressed versions of the video files and to transmit those compressed versions over the transmission channel. The compressed versions can then be decompressed and displayed to the editor. Suitable compression methods include MPEG, MJPEG, and other discrete-cosine transform based methods.

A disadvantage of transmitting compressed files is the degradation associated with the compression. The extent of this degradation is determined at the time of compression, and cannot be adjusted in response to changing circumstances. Thus, if one were working with only one or two video streams, in which case one would likely have bandwidth to spare, the image would be as degraded as it would have been had one been working with ten or more video streams.

### SUMMARY

In one aspect, the invention includes a storage medium and a processing element in data communication with the storage medium. Stored on the storage medium are frames of progressively-encoded frame data. These stored frames represent a portion of a video stream. The processing element is configured to fetch, from each frame, a selected extent of the frame data.

A variety of progressively-encoded formats are available. However, in one embodiment, the frame data includes wavelet-transform encoded data.

In one embodiment, the processing element also includes a decoder for transforming the frame data into a form suitable for display on a display device.

In another embodiment, the processing element is configured to execute an editing process for receiving an instruction specifying the selected extent.

In another embodiment, the processing element is configured to execute an editing process to adaptively control the selected extent on the basis of traffic on a data transmission channel that provides data communication between the processing element and the storage medium.

In yet another embodiment, the processing element is configured to execute an editing process to fetch an additional extent of the frame data in response to detection of a pause in displaying the video stream.

In another aspect, the invention includes a method for displaying data representative of a video stream by providing frames containing progressively-encoded frame data. These frames represent a portion of the video stream. A selected extent of the frame data contained in each frame is then fetched, and a video stream corresponding to the selected extents is displayed.

A variety of encoding formats are available for encoding progressively-encoded frame date. However, in at least one practice of the invention, the frame data includes wavelet-transform encoded representations of images.

Other practices include those in which fetching a selected extent includes receiving an instruction specifying the selected extent; or receiving an instruction specifying a desired image quality, and then selecting an extent consistent with the desired image quality; or monitoring data traffic on a transmission channel, and then determining an extent to retrieve on the basis of the traffic.

Yet another practice includes determining that a display of the selected extent of frame data is paused, and fetching an additional extent of the frame data.

In another aspect, the invention includes a computer-readable medium having encoded thereon software for displaying data representative of a video stream represented by frames containing progressively-encoded frame data. The software includes instructions for fetching a selected extent of the frame data contained in each frame; and displaying a video stream corresponding to the selected extents.

As used herein, the term “progressive” (and its variants) refers to the ordering of the encoded data. It is not intended to identify types of video frames and/or fields.

As used herein, the term “frame” (and its variants) is intended to refer to a specific set of encoded data. It is not intended to refer to a “video frame” or “video field,” except insofar as either of these is the original source of the data referred to.

Unless otherwise defined, all technical and scientific terms used herein have the same meaning as commonly understood by one of ordinary skill in the art to which this invention belongs. Although methods and systems similar or equivalent to those described herein can be used in the practice or testing of the present invention, suitable methods and systems are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

FIG. 1 shows a video editing system;

FIG. 2 is a schematic view of a video data file containing progressively-encoded frame data;

FIGS. 3A and 3B show different image qualities resulting from changing the extent of the frame data used to render the images; and

FIGS. 4 and 5 are schematic views of a video data file showing differing selected extents of frame data.

### DETAILED DESCRIPTION

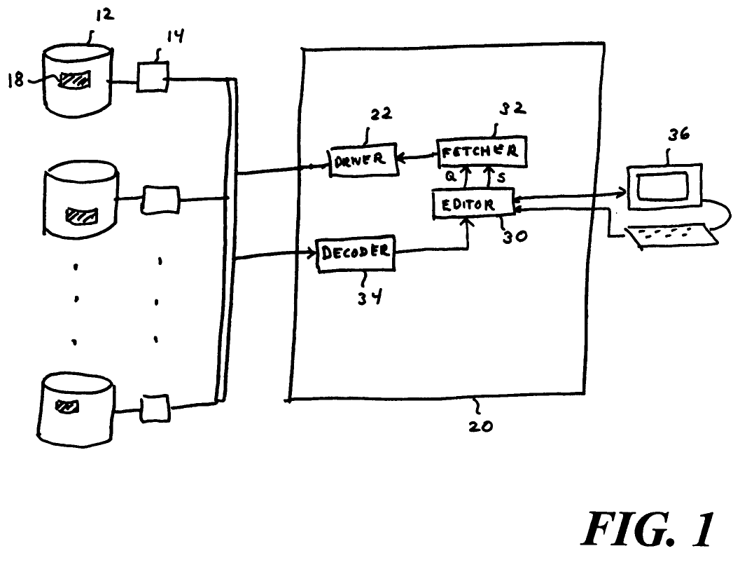

Referring to FIG. 1, an editing system 10 includes one or more disks 12 controlled by respective disk controllers 14. The disk controllers 14 are in data communication with a data-transmission channel, which in this case is a system bus 16. Each disk 12 includes one or more progressively-encoded video files 18. A processing element 20, also in communication with the system bus 16, includes a disk driver 22 whose function is to instruct the disk controllers 14 to fetch selected portions of the video files 18 and to place those portions on the bus 16.

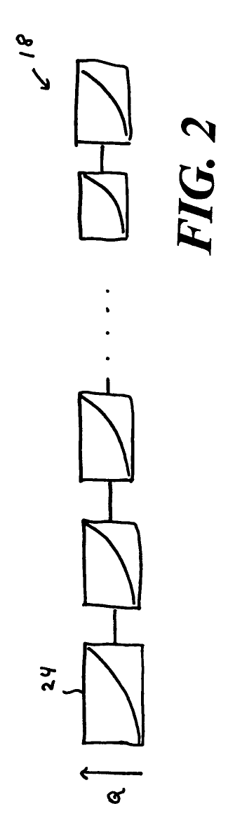

As shown in FIG. 2, a progressively-encoded video file 18 is a sequence of frames 24, each of which contains progressively-encoded data, hereinafter referred to as “frame data,” representing an image. To display a video stream, the images from a selected video file 18 are sequentially displayed to a viewer at a rate sufficient to maintain the illusion of motion.

A salient property of a progressively-encoded video file 18 is that one can transmit a complete image without having to transmit all of the frame data contained in the frame 24 corresponding to that image. If only a small fraction of the frame data is transmitted, the quality of the resulting image will be poor, but the image will nevertheless be complete. To improve the quality of the image, it is only necessary to transmit more of the frame data. This property of a progressively-encoded video file 18 is suggested in FIG. 2 by a qualitative graph showing the image quality for each frame 24 as a function of the extent of the data used to render the image corresponding to that frame 24. As suggested by the graph, when only a small fraction of the frame data is used, the resulting image quality is low. As more and more of the frame data is used, the image quality continuously improves.

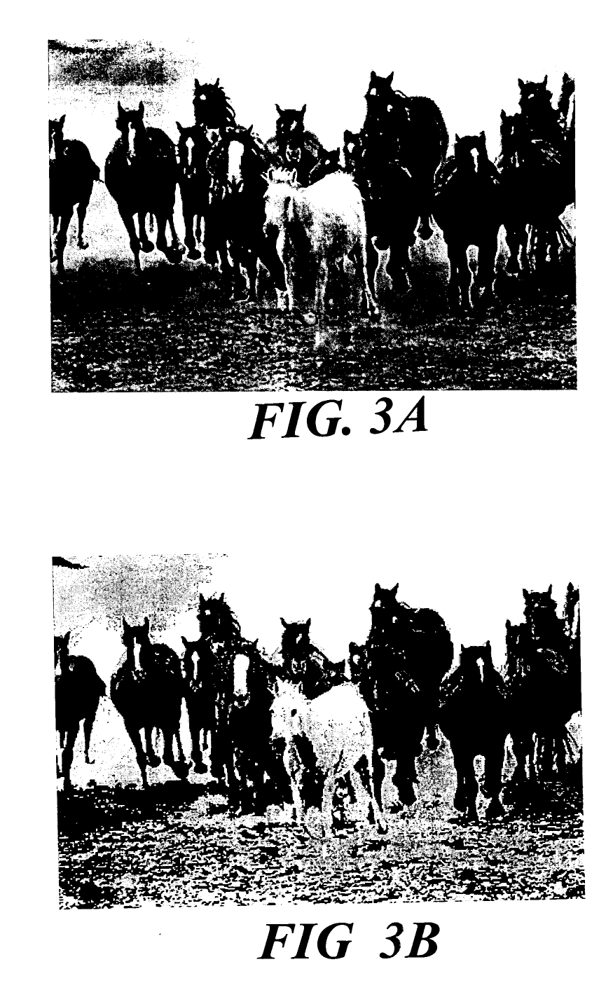

As used herein, an image is “complete” if each pixel making up the image has been assigned a value. The value assigned to each pixel may change depending on the extent of the frame data that is fetched to render the image. However, a value is present for each pixel even if only a small fraction of the frame data has been fetched. As a result, a complete image avoids dark bands or regions resulting from missing data. FIGS. 3A and 3B are representative examples showing a poor quality image resulting from having used only a small fraction of the frame data (FIG. 3A) and a good quality image resulting from having used a larger fraction of the frame data (FIG. 3B).

In a progressively-encoded video file 18, the position of frame data within a frame 24 is related to the importance of that frame data in rendering a recognizable image. In particular, the frame data is arranged sequentially, beginning with the most important frame data and ending with the least important frame data. This arrangement of frame data is analogous, for example, to a well-written newspaper article in which the most important portions are placed near the beginning of the article and portions of lesser importance are placed near the end of the article.

Alternatively, the frame data can be arranged with the most important frame data at the end of the frame 24 and the least important frame data at the beginning of the frame 24. What is important is that there exist a relationship between the importance of the frame data and the position of that frame data within the frame 24.

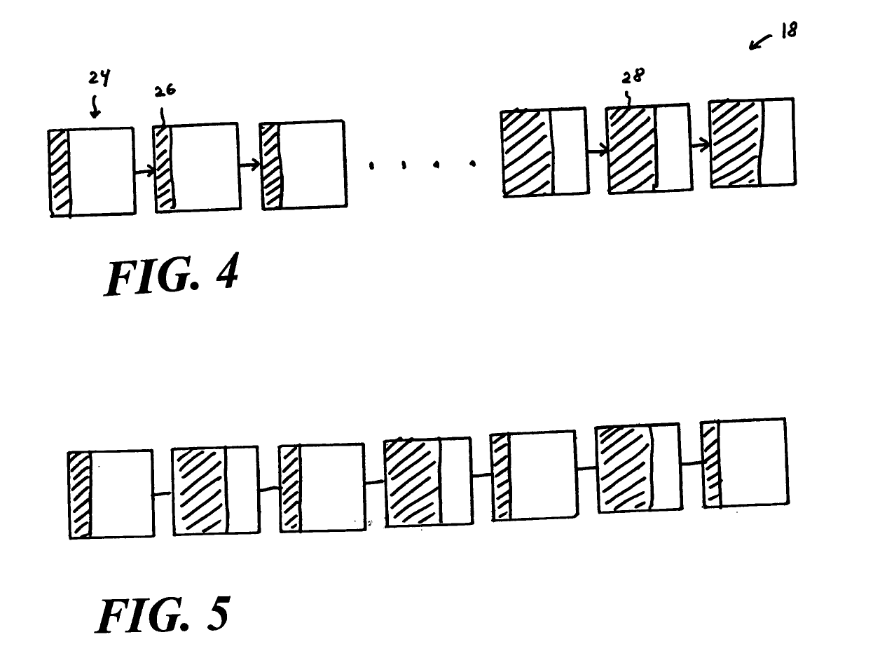

Because the image quality is a continuous function of the extent of the frame data used to render the image, it is possible for an editor to dynamically make compromises between displayed image quality and bandwidth consumption on the bus 16. For example, FIG. 4 shows a sequence of frames 24 from a video file 18. In the first few frames, the editor has specified that only a small fraction 26 of frame data be fetched from each frame 24. This will result in the display of an image having significant image degradation. However, later on, the editor has become more interested in the video stream represented by this video file 18. As a result, the editor has requested that a greater fraction 28 of the frame data be fetched from the latter frames.

It is also possible for the editor to specify a time-varying pattern that controls the selected extents of frame data. For example, in FIG. 5, the editor has specified that the fetching of smaller extents 26 and larger extents 28 of frame data be interleaved. Other, more complex time-varying patters can likewise be specified.

A variety of image encoding methods are available for encoding an image into progressively-encoded frame data as described above. A well-known method is to store data representative of the wavelet transform of an image into a frame 24. The wavelet transform coefficients can then be arranged within the frame 24 to correspond to the relative importance of those coefficients in reconstructing the image.

The sequential arrangement of frame data by its importance enables the frame data to be drawn off each video file 18 on an as-needed basis. For example, an editor who is working with only two video streams may have sufficient bandwidth to request all the frame data from each frame 24. On the other hand, an editor who is working with a dozen video streams may prefer not to consume bandwidth with such profligacy. Such an editor may request only a small portion of the frame data from each frame 24. In some cases, a video editor may be particularly interested in one or two of several video streams. In such a case, the editor may specify a larger extent of the frame data for those two video streams of particular interest and that smaller extents of the frame data for the remaining video streams. This ability to control image quality by reading selected extents of the frame data effectively achieves what amounts to dynamic compression of the video data, with the extent of compression, and hence the degradation of image quality, being selected at the time of data transmission.

Referring back to FIG. 1, a human video editor provides editing instructions to an editing process 30 executing on the processing element 20. Among these instructions are specifications for which video streams (“S”) to fetch from a disk 12 and how much of the frame data (“Q”) to fetch from each video stream. The extent of the frame data, referred to herein as a “fetch value,” to be fetched can be controlled directly, by having the human editor specify an extent to be fetched or indirectly, for example by having the editor specify a desired quality level and relying on the editing process 30 to determine the corresponding fetch value. Alternatively, the editing process 30 can monitor traffic on the bus 16 and dynamically alter the fetch value in response to that traffic, or in response to the number of video streams being displayed.

The editing process 30 provides a fetching process 32 with instructions on which video streams to fetch and how much of each frame to fetch. The fetching process 32 then communicates these instructions to the disk driver 22, which in turn causes the appropriate disk controllers 14 to place the required data on the bus 16.

The data placed on the bus 16 represents the wavelet transform of the image. As a result, before being displayed it must be translated, or decoded, into a form suitable for display. This is carried out by a decoding process 34 in communication with both the editing process 30 and with a display 36.

In the course of editing, there may be times during which one or more of the video streams is paused. For example, in many cases, a video editor spends a great deal of time moving or re-sizing static images on the screen. During this time, the bandwidth of the bus 16 is not being fully utilized.

In one embodiment of the editing system 10, the editing process 30 is configured to request additional frame data during such pauses. When this is the case, a paused image will gradually improve its appearance on the display 36 as additional portions of the frame data representing that image are provided to the display 36. This allows recovery of otherwise wasted bandwidth.

The output of the editor 30, which is normally provided to the display 36, will be referred to as a “rendered image.” This output is typically a composite image made by combining two or more video streams.

In an alternative practice of the invention, the rendered image is stored as a progressively-encoded video file 18 instead of being provided to the display 36. The video file 18, which may have originally been several video streams, can then be provided as a single video stream to be combined with other video streams in the manner described above.

1. A video-editing system comprising:
a storage medium having stored therein frames of progressively-encoded frame data, the stored frames being representative of a portion of a video stream;
a processing element in data communication with the storage medium, the processing element being configured to fetch, from each frame, a selected extent of the frame data.

2. The system of claim 1, wherein the processing element comprises a decoder for transforming the frame data into a form suitable for display on a display device.

3. The system of claim 1, wherein the processing element is configured to execute an editing process for receiving an instruction specifying the selected extent.

4. The system of claim 1,wherein the processing element is configured to execute an editing process to adaptively control the selected extent on the basis of traffic on a data transmission channel providing data communication between the processing element and the storage medium.

5. The system of claim 1, wherein the processing element is configured to execute an editing process to fetch an additional extent of the frame data in response to detection of a pause in displaying the video stream.

6. The system of claim 1, wherein the frame data comprises wavelet-transform encoded data.

7. The system of claim 1, wherein the frame data comprises data representative of a rendered image.

8. A method for displaying data representative of a video stream, the method comprising:
providing frames containing progressively-encoded frame data, the frames being representative of a portion of the video stream;
fetching a selected extent of the frame data contained in each frame; and
displaying a video stream corresponding to the selected extents.

9. The method of claim 8, wherein providing frames containing progressively-encoded frame data comprises providing frames containing wavelet-transform encoded representations of images.

10. The method of claim 8, wherein fetching a selected extent comprises receiving an instruction specifying the selected extent.

11. The method of claim 8, wherein fetching a selected extent comprises:
receiving an instruction specifying a desired image quality; and
selecting an extent consistent with the desired image quality.

12. The method of claim 8, wherein fetching a selected extent comprises:
monitoring data traffic on a transmission channel; and
determining an extent to retrieve on the basis of the traffic.

13. The method of claim 8, further comprising:
determining that a display of the selected extent of frame data is paused, and
fetching an additional extent of the frame data.

14. The method of claim 8, wherein providing frames comprises providing frame data representative of a rendered image.

15. A computer-readable medium having encoded thereon software for displaying data representative of a video stream represented by frames containing progressively-encoded frame data, the software comprising instructions for:
fetching a selected extent of the frame data contained in each frame; and
displaying a video stream corresponding to the selected extents.

16. The computer-readable medium of claim 15, wherein the frames contain wavelet transform encoded representations of images and the software further comprises instructions decoding wavelet-transform encoded images.

17. The computer-readable medium of claim 15, wherein the instructions for fetching a selected extent comprise instructions for receiving a specification of the selected extent.

18. The computer-readable medium of claim 15, wherein the instructions for fetching a selected extent comprise instructions for:
receiving an specification of a desired image quality; and
selecting an extent consistent with the desired image quality.

19. The computer-readable medium of claim 15, wherein the instructions for fetching a selected extent comprise instructions for:
monitoring data traffic on a transmission channel; and
determining an extent to retrieve on the basis of the traffic.

20. The computer-readable medium of claim 15, wherein the software further comprises instructions for:
determining that a display of the selected extent of frame data is paused, and
fetching an additional extent of the frame data.
